(19) United States
(12) Patent Application Publication
(10) Pub. No.: US 2010/0321151 A1
(43) Pub. Date: Dec. 23, 2010

(54) HOME AUTOMATION SECURITY SYSTEM AND METHOD

(75) Inventors: Craig Matsuura, Draper, UT (US); Greg Cooper, Highland, UT (US); Thomas Leishman, Holladay, UT (US)

Correspondence Address: THORPE NORTH & WESTERN, LLP., P.O. Box 1219, SANDY, UT, 84091-1219, US

(73) Assignee: CONTROL4 CORPORATION, Draper, UT (US)

(21) Appl. No.: 12/098,308

(22) Filed: Apr. 4, 2008

Related U.S. Application Data
(60) Provisional application No. 60/910,193, filed on Apr. 4, 2007.

(51) Int. Cl. G06F 7/04; G06F 17/30

(52) U.S. Cl. 340/5.52; 707/769; 707/E17.014

(57) ABSTRACT

A control system for allowing access to the use of home automation devices. The control system can include at least one home automation device. A biometric scanner can gather biometric data from a user. An automation controller can be in networked communication with the home automation device and the biometric scanner. The receive controller can process biometric data from the biometric scanner to enable access to the at least one home automation device.

### CROSS-REFERENCE TO RELATED APPLICATIONS AND CLAIM OF PRIORITY

Priority of U.S. Provisional patent application Ser. No. 60/910,193 filed on Apr. 4, 2007 is claimed.

### BACKGROUND

Home automation systems are computer networks that connect various home automation devices to a central home automation control device, such as a computer or main controller component. The central control device can be programmed to turn on, turn off, or adjust the settings of the various home automation devices. For example, various home automation devices such as televisions, heating and air conditioning equipment, lights, window shades or curtains, pool heaters and filtration systems, lawn sprinklers, ornamental fountains, audio/visual equipment, fireplaces, and other appliances or devices can all be in communication with and controlled by the central control device. Thus, the home automation system can automatically engage and adjust such home automation devices according to a desired program set by the user.

Home automation systems are often used to set and maintain several home automation devices in a predetermined state or scene. For example, a home automation system can be programmed to turn on the lights, adjust the thermostat temperature, turn a stereo on for background music, and preheat an oven when a remote event, such as a garage door opening is received by the home automation controller. In this way, home automation can set the scene of the home in preparation for the arrival of the home's occupants at the end of a work day.

Similarly, home automation systems can also be integrated with a home security system so that when a fire or burglar alarm is raised, the controller can turn on lights or audible alarms. Additionally, entertainment equipment such as audio, video, and home theatre equipment can be in communication with the controller to enable a remote device to activate the equipment according to programmed schedules or remotely input commands.

Scene and schedule programs, as described above, can be programmed into the controller for multiple users. For example, one user may prefer louder background music or a particular television program, while another user may have different preferences. In this case, the controller can activate a distinct scene program according to a user login in order to customize the home for each user. Home automation systems provide great convenience and allow for some customization of individual automated devices. However, home owners often desire greater control over the devices and appliances in their home. A homeowner may want to lock out certain users from a particular device, or allow only partial access to a device. For example, a parent may want to limit a child's access to a television or allow access to some television stations and restrict access to others. Similarly, a host may want to restrict a guest's ability to access computers or temperature controls.

Unfortunately, while current home automation systems may turn off, turn on, or adjust the setting of a device such systems have not generally been able to lock out or partially restrict access to the device. Usually the controller can be manually overridden by a user at the physical location of the device. Often the device can be separated from the home automation controller and operated independently from the home automation system. Thus, a home automation system is effective at controlling devices, but not effective at restricting access to the home automation devices.

### SUMMARY

The present invention provides for a control system for allowing access to the use of home automation devices. The control system can include at least one home automation device. A biometric scanner can gather biometric data from a user. An automation controller can be in networked communication with the home automation device and the biometric scanner. The automation controller can process biometric data from the biometric scanner to enable access to the at least one home automation device.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a block diagram of a home automation device network in accordance with an embodiment of the present invention;

FIG. 2 is a schematic view of a control system for a home automation device in accordance with another embodiment of the present invention; and

FIG. 3 is a flow chart illustrating a method for controlling the use of a home automation device.

Reference will now be made to the exemplary embodiments illustrated, and specific language will be used herein to describe the same. It will nevertheless be understood that no limitation of the scope of the invention is thereby intended.

### DETAILED DESCRIPTION OF EXEMPLARY EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. The following detailed description and exemplary embodiments of the invention will be best understood by reference to the accompanying drawings, wherein the elements and features of the invention are designated by numerals throughout.

The present system and method are directed to a home automation control system for controlling the use of automated devices, such as televisions, heating and air conditioning equipment, lights, window shades or curtains, pool heaters and filtration systems, lawn sprinklers, ornamental fountains, audio/visual equipment, fireplaces, and the like. The home automation control system can include a biometric scanner, such as a palm, thumb or finger print scanner, a retinal scanner, face recognition scanner, voice recognition protocol, or the like, that can identify a user.

The control system can also include an automation controller or receiver that can be in networked communication with the home automation devices and the biometric scanner. The automation controller can verify the biometric data from the biometric scanner to log the user in to the home automation network. The automation controller can also enable partial or full access to the home automation devices based on the biometric login from the scanner. For example, the automation controller can enable partial access to a television or television stations when a child or guest logs into the system or allow full access to the television and all the television stations when an adult or system administrator logs in. In this way, the home automation control system can provide security access to previously unsecured home automation devices.

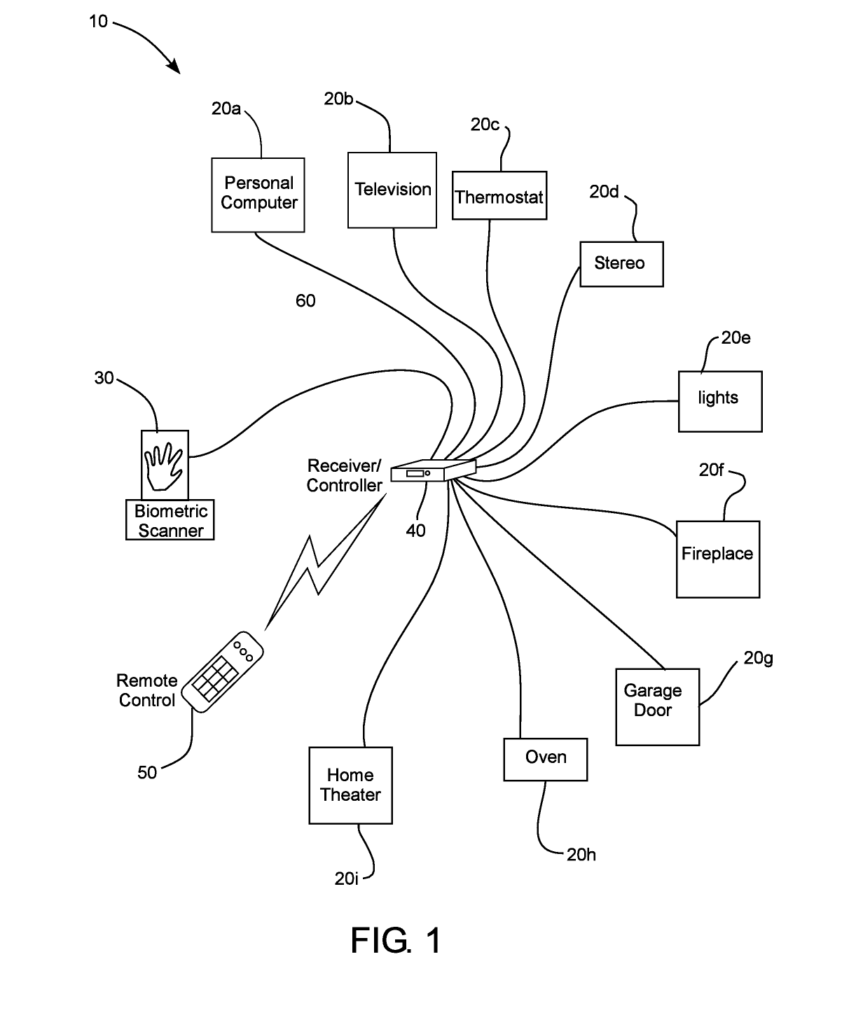

As illustrated in FIG. 1, a control system, indicated generally at 10, is shown in accordance with an embodiment for allowing access to the use of home automation devices. The control system 10 can include at least one home automation device 20a-i. For example, the one or more home automation devices 20a-i can include a television, a VCR, a DVD player, a DVD recorder, a light, a thermostat, a garage door opener, a computer, audiovisual equipment, entertainment equipment, a hot tub, a fireplace, an oven, a cooking range, a microwave, a clock radio, an alarm system, an electronic door lock device, heating and air conditioning equipment, window shades or curtains, pool heaters and filtration systems, lawn sprinkler controls, and ornamental fountains.

The control system 10 can also include a biometric scanner 30. The biometric scanner 30 can scan a user for biological identification information. The biometric scanner 30 can be a thumb print scanner, a finger print scanner, a palm scanner, a retinal scanner, a face recognition scanner, a voice recognition scanner, a visual recognition device, or the like. The biometric scanner 30 can gather biometric data from a user to identify the user to the control system 10. The biometric scanner 30 can be embedded into a touch control panel, a remote control, a key fob, a mini-touch screen, a keyboard, a keypad, a switch, a dimmer switch, an alarm control, a thermostat, or the like. In this way, the biometric scanner 30 can be placed in a convenient and inconspicuous location to enhance the usability and security of the control system 10.

The control system 10 can also include an automation controller 40. The automation controller 40 can be a programmable receiver or other electronic device, for controlling a home automation network. The automation controller 40 can be in networked communication with the home automation devices 20 and the biometric scanner 30. The communication network between the automation controller and the home automation devices can be accomplished through wired or wireless means. The communication means can include any communication between the media controller and the electronic devices using RF wireless communication such as a standardized communication format under IEEE 802 or any other standardized or proprietary wireless communication scheme. For example, connections between the devices may be wireless connections having a predetermined bandwidth, coaxial connections, wired connections, optical connections, and connections of a specified format such as USB, IEEE 1394, 802.11, Zigbee, HDMI, DVI, component connections, and the like. Communication means can further include optical communication such as infrared or fiber optic communication, or wired communication through a wired connection such as a serial RS 232, USB, Firewire, or some other type of connection configured to transmit information between the media controller and the media wall electronic devices.

The automation controller 40 can also receive biometric data from the biometric scanner 30. The automation controller 40 can process the biometric data from the biometric scanner 30 to enable access to the home automation devices 20 by comparing or verifying the received biometric data with known biometric data stored in resident memory or database of the automation controller.

The control system 10 can also include a database of biometric data. The database can include biometric data from a group of known users of the control system 10. The database can be accessible by the automation controller 40. For example, the database can be stored in resident memory of the automation controller 40. Thus, the automation controller 40 can receive biometric data from the biometric scanner 30 and can verify the biometric data with the biometric database to identify the user attempting to access the home automation device 20 or control system 10 through the biometric scanner 30. In this way, the automation controller 40 can enable a predetermined level of access to the home automation devices 20 based on the biometric login verification. Additionally, the automation controller 40 can restrict access to the home automation devices 20 in the case of an unknown biometric scan.

The automation controller 40 can also include a security protocol. The security protocol can restrict access to the home automation devices 20 networked to the automation controller 40. For example, the automation controller 40 can receive biometric data from the biometric scanner 30 and can verify the biometric data with the biometric database to identify the user attempting to access the home automation device 20 or control system 10 through the biometric scanner 30. If the user is a known user that is verifiable with the database then the automation controller 40 can enable an access level to the home automation devices 20 networked to the automation controller. The access level can allow partial or complete access to one or more of the devices networked to the automation controller.

In this way, the automation controller 40 can be used to limit the access of some approved users. Thus, if a child uses the biometric scanner 30, the automation controller 40 can verify that the biometric data belongs to a child and can enable only partial access to selected home automation devices, such as a television. Accordingly, the automation controller 40 can control the time of the day the television is available to the child user, as well as the television stations available to the child user.

On the other hand, if the user is not a known user and the biometric data cannot be verified, the automation controller 40 can lock the control system 10 to completely restrict use of the home automation devices 20. Additionally, if the user is not a known user, the automation controller 40 can allow limited access to the home automation devices 20 as a guest user.

It will be appreciated that the automation controller 40 can control the lengths of time as well as the times of the day that automation devices controlled by the automation controller are available for use to particular users. Thus, the automation controller can allow a parent to limit the time of the day a child can access a television or video game system as well as the total amount of time the child can access such devices.

Thus, it is a particular advantage of the present invention that the automation controller 40 can enable only partial access of the home automation devices 20 to the user. In this way, a multi-level access system can be established with a top level authorization having access to all the home automation devices and lower levels of authorization with only partial or limited access to the home automation devices.

In one embodiment, the home automation controller system and many of the home automation devices can also be locked in a separate room or closet to provide additional security to the home automation devices. For example, a DVD player or satellite TV system may be otherwise easy to override using the physical controls on the device's faceplate. However, the DVD player and satellite system may be locked in the separate room. Then the only access is to the devices is through the home automation controller and its accompanying biometric security system.

Additionally, the home automation devices can have electronic security protocols, such as password protections, in order to restrict access to the settings and faceplate controls of the networked home automation devices. Furthermore, the automation controller can provide additional security access to the home automation devices networked to the home automation controller by controlling the power supply in the home automation devices or the power supplied from an AC main at the locations of the home automation devices.

The automation controller 40 can also include an interface 50 for allowing a user to input and access data. The interface 50 can be a keyboard, a touch screen, a remote control, a USB port, an RS 232 port, a serial port, a parallel port, a wireless transmitter/receiver, or the like. The interface can allow the user to program the automation controller 40 in order to customize the settings of the networked home automation devices 20 so that upon activation by the automation controller 40 the home automation devices 20 can adjust to a preprogrammed state or setting. In this way, the automation controller 40 can be used to “set a scene” in a home.

In use the automation controller 40 can receive biometric data from the biometric scanner 30 and can verify the biometric data with the biometric database to identify the user attempting to access the home automation devices 20 or control system 10 through the biometric scanner 30. Upon verification, the automation controller 40 can access a program associated with the particular user that has biometrically logged in to the system, and can adjust the home automation devices to preprogrammed settings preferred by the user.

It is a particular advantage of the present invention that the automation controller 40 can both enable and restrict access to the home automation devices 20. In this way, the automation controller 40 not only acts as a home automation control system that allows control of a home environment, but also acts as a security system for each individual home automation device networked to the automation controller. Thus, the present system and method advantageously provides a security lockout for home automation devices that may not have built in security features. For example, the automation controller can provide a security lockout for a television, audio/visual equipment, home theater system, heating and air conditioning thermostat, and the like.

The automation controller 40 can communicate with the home automation devices 20 and the biometric scanner 30 through communication devices 60. The communication devices 60 can be wired communication devices such a Ethernet, USB port, RS 232 port, serial port, parallel port, coaxial cable, cable, data cable, optical cable, a wireless mesh network, or combinations thereof. Additionally, the communication devices 60 can be wireless communication device such as an RF transmitter/receiver, or infrared transmitter/receiver.

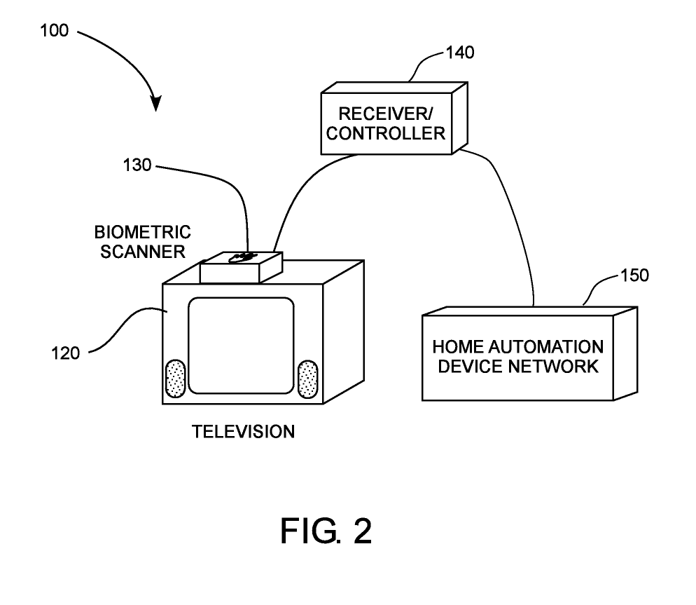

FIG. 2 illustrates an embodiment of a control system, indicated generally at 100, for a home automation device 120 for use in directly enabling a single home automation device 120 and then the entire network. The control system 100 can be similar in many respects to the control system 10 shown in FIG. 1 and described above.

Additionally, the control system 100 can include a biometric scanner 130 associated with the home automation device 120. The biometric scanner 130 can be coupled directly to the home automation device 120 or can be a separate device positioned at a remote location. The control system 100 can also include an automation controller 140 that can be in networked communication with the biometric scanner 130 and the home automation device 120. Thus, the control system 100 can be an integrated unit that can be coupled to or associated with a home automation device 120.

In use, the biometric scanner 130 can scan biometric data from a user and transmit the biometric data to the automation controller 140. The automation controller 140 can receive the biometric data and can verify the identity of the user by comparing the biometric data to a database of known biometric profiles. The known biometric profiles may be stored in a local storage device for the biometric scanner or the profiles can be accessed on the network by the biometric scanner. The automation controller 140 can enable access to the home automation device 120 based on verification of the biometric scan to allow the user to turn the home automation device on or off or to adjust the settings of the home automation device. The automation controller can also be networked together with a plurality of other automatable devices to form a home automation network 150.

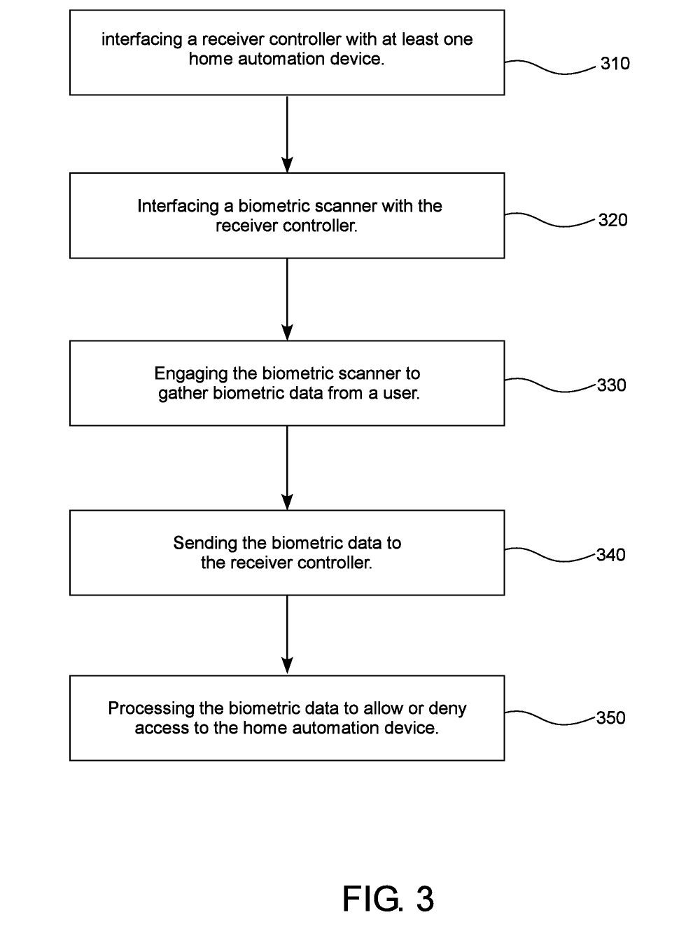

FIG. 3 is a flow chart illustrating a method for controlling the use of a home automation device. The method includes interfacing an automation controller with a home automation device, as shown at 310. A biometric scanner can be interfaced with the automation controller, as shown at 320. The biometric scanner can be engaged to gather biometric data from a user, as shown at 330. The biometric data can be sent to the automation controller, as shown at 340, and the biometric data can be processed to allow or deny access to the home automation device, as shown at 350.

The method can also include comparing the biometric data with a database to verify the identity of the user and enable at least partial access to the home automation device based on the biometric data.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed:

1. A control system for controlling access to use of home automation devices, comprising:
a home automation device;
a biometric scanner configured to gather biometric data from a user; and
an automation controller in networked communication with the home automation device and configured to receive and process biometric data from the biometric scanner to enable access to the home automation device.

2. The control system of claim 1, wherein the automation controller further includes:
a database of biometric data accessible by the automation controller, wherein the automation controller verifies the biometric data from the biometric scanner with the biometric database to enable at least partial access to the home automation device based on the verification.

3. The control system of claim 1, wherein the automation controller further includes a security protocol configured to restrict access to the home automation device.

4. The control system of claim 1, wherein the automation controller further includes a user interface configured to allow a user to customize the settings of the home automation device upon activation by the automation controller.

5. The control system of claim 1, wherein the automation controller is in communication with the home automation device by a communication protocol.

6. The control system of claim 5, wherein the communication protocol is selected from the group consisting of a USB, RS 232, RF transmitter/receiver, infrared transmitter/receiver, serial port, and combinations thereof.

7. The control system of claim 1, wherein the automation controller is configured to provide a customized response of the home automation device based on a verification of the biometric data from the biometric scanner against a database of biometric data.

8. The control system of claim 1, wherein the automation controller is programmable to enable limited security access to the home automation device based on a verification of the biometric data from the biometric scanner with a database of biometric data.

9. The control system of claim 1, wherein the biometric scanner is selected from the group consisting of a thumb print scanner, a finger print scanner, a palm scanner, a retinal scanner, a voice scanner, image recognition, and combinations thereof.

10. The control system of claim 1, wherein the home automation device is selected from the group consisting of a television, a VCR, a DVD player, a DVD recorder, a light, a thermostat, a garage door opener, a computer, audiovisual equipment, entertainment equipment, a pool heater, a pool pump, a hot tub, a fireplace, an oven, a cooking range, a microwave, a clock radio, an alarm system, an electronic locking device, and combinations thereof.

11. A control system for home automation devices, comprising:
a home automation device;
a biometric scanner associated with the home automation device, and configured to gather biometric data from a user; and
an automation controller in networked communication with the home automation device and the biometric scanner and configured to process biometric data from the biometric scanner to enable direct access to the at least one home automation device.

12. The control system of claim 11, wherein the automation controller enables access to a network of home automation devices in communication with the automation controller based on the biometric data from the biometric scanner.

13. The control system of claim 11, wherein the automation controller further comprises:
a database of biometric data accessible by the automation controller; and
wherein the automation controller verifies the biometric data from the biometric scanner against the biometric database to enable a defined level of access to the home automation device based on the verification.

14. The control system of claim 11, wherein the automation controller further includes a security protocol algorithm configured to restrict access to the home automation device.

15. The control system of claim 11, wherein the automation controller is programmable to customize a response of the home automation device based on a verification of the biometric data from the biometric scanner with a database of biometric data.

16. The control system of claim 11, wherein the biometric scanner is selected from the group consisting of a thumb print scanner, a finger print scanner, a palm scanner, a retinal scanner, a voice scanner, and combinations thereof.

17. The control system of claim 11, wherein the home automation device is selected from the group consisting of a television, a VCR, a DVD player, a DVD recorder, a light, a thermostat, a garage door opener, a computer, audiovisual equipment, entertainment equipment, a pool heater, a pool pump, a hot tub, a fireplace, an oven, a cooking range, a microwave, a clock radio, an alarm system, an electronic locking device, and combinations thereof.

18. A control system for home automation devices, comprising:
at least one home automation device;
a biometric scanner configured to gather biometric data from a user; and
an automation controller in networked communication with the home automation device and configured to process biometric data from the biometric scanner to enable access to the at least one home automation device and customize the set up and use of the at least one home automation device based on a biometric login by the biometric scanner.

19. The control system of claim 18, wherein the automation controller further includes:
a database of biometric data accessible by the automation controller, wherein the automation controller verifies the biometric data from the biometric scanner with the biometric database to enable a defined level of access to the home automation device based on the verification.

20. The control system of claim 18, wherein the biometric scanner is selected from the group consisting of a thumb print scanner, a finger print scanner, a palm scanner, a retinal scanner, a voice scanner, and combinations thereof.

21. A method for controlling the use of a home automation device, comprising:
interfacing an automation controller with at least one home automation device;
interfacing a biometric scanner with the automation controller;
engaging the biometric scanner to gather biometric data from a user;
sending the biometric data to the automation controller; and
processing the biometric data to provide a defined level of access to the home automation device.

22. The method of claim 21, further comprising:
comparing the biometric data with a database to verify the identity of the user and enable at least partial access to the home automation device based on the biometric data.

23. A method for enabling a home automation device, comprising:
engaging a biometric scanner to gather biometric data from a user;
sending the biometric data to an automation controller; and
processing the biometric data to provide a defined level of access to a home automation device.
